(19) United States
(12) Patent Application Publication
(10) Pub. No.: US 2024/0144585 A1
(43) Pub. Date: May 2, 2024

(54) SYSTEMS AND METHODS FOR ADJUSTING LIGHTING INTENSITY OF A FACE CHART

(71) Applicant: Perfect Mobile Corp., New Taipei City (TW)

(72) Inventors: I-Ting SHEN, New Taipei City (TW); Yi-Wei LIN, New Taipei City (TW); Pei-Wen HUANG, Taipei City (TW)

(21) Appl. No.: 18/494,945

(22) Filed: Oct. 26, 2023

Related U.S. Application Data
(60) Provisional application No. 63/380,975, filed on Oct. 26, 2022.

(51) Int. Cl. G06T 15/50; G06T 7/90; G06T 19/20; G06V 10/56; G06V 40/16

(52) U.S. Cl. CPC G06T 15/506; G06T 7/90; G06T 19/20; G06V 10/56; G06V 40/168; G06T 2207/10024; G06T 2207/20081; G06T 2207/30088; G06T 2207/30201; G06T 2219/2012

(57) ABSTRACT

A computing device obtains an image depicting a face of a user. The computing device identifies facial features in the image and extracts characteristics of the facial features in the image. The computing device generates a two-dimensional (2D) face chart based on the facial feature characteristics. The computing device predicts a skin tone of the user's face depicted in the image of the user and changes color in a color map of a predefined three-dimensional (3D) model based on the predicted skin tone. The computing device selects a predefined environment map based on characteristics in the image depicting the face of the user and generates a target face image based on the predefined 3D model.

### CROSS-REFERENCE TO RELATED APPLICATION

This application claims priority to, and the benefit of, U.S. Provisional Patent Application entitled, “Auto detection for face chart lighting intensity,” having Ser. No. 63/380,975, filed on Oct. 26, 2022, which is incorporated by reference in its entirety.

### TECHNICAL FIELD

The present disclosure generally relates to systems and methods for adjusting the lighting intensity of face charts.

### SUMMARY

In accordance with one embodiment, a computing device obtains an image depicting a face of a user. The computing device identifies facial features in the image and extracts characteristics of the facial features in the image. The computing device generates a two-dimensional (2D) face chart based on the facial feature characteristics. The computing device predicts a skin tone of the user's face depicted in the image of the user and changes color in a color map of a predefined three-dimensional (3D) model based on the predicted skin tone. The computing device selects a predefined environment map based on characteristics in the image depicting the face of the user. The computing device generates a target face image based on the predefined 3D model.

Another embodiment is a system that comprises a memory storing instructions and a processor coupled to the memory. The processor is configured by the instructions to obtain an image depicting a face of a user. The processor is further configured to identify facial features in the image and extract characteristics of the facial features in the image. The processor is further configured to generate a two-dimensional (2D) face chart based on the facial feature characteristics. The processor is further configured to predict a skin tone of the user's face depicted in the image of the user and change color in a color map of a predefined three-dimensional (3D) model based on the predicted skin tone. The processor is further configured to select a predefined environment map based on characteristics in the image depicting the face of the user. The processor is further configured to generate a target face image based on the predefined 3D model.

Another embodiment is a non-transitory computer-readable storage medium storing instructions to be implemented by a computing device. The computing device comprises a processor, wherein the instructions, when executed by the processor, cause the computing device to obtain an image depicting a face of a user. The processor is further configured by the instructions to identify facial features in the image and extract characteristics of the facial features in the image. The processor is further configured by the instructions to generate a two-dimensional (2D) face chart based on the facial feature characteristics. The processor is further configured by the instructions to predict a skin tone of the user's face depicted in the image of the user and change color in a color map of a predefined three-dimensional (3D) model based on the predicted skin tone. The processor is further configured by the instructions to select a predefined environment map based on characteristics in the image depicting the face of the user. The processor is further configured by the instructions to generate a target face image based on the predefined 3D model.

Other systems, methods, features, and advantages of the present disclosure will be apparent to one skilled in the art upon examining the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Various aspects of the disclosure are better understood with reference to the following drawings. The components in the drawings are not necessarily to scale, with emphasis instead being placed upon clearly illustrating the principles of the present disclosure. Moreover, in the drawings, like reference numerals designate corresponding parts throughout the several views.

FIG. 1 is a block diagram of a computing device configured adjust the lighting intensity of a face chart to enhance a three-dimensional (3D) effect according to various embodiments of the present disclosure.

FIG. 2 is a schematic diagram of the computing device of FIG. 1 in accordance with various embodiments of the present disclosure.

FIG. 3 is a top-level flowchart illustrating examples of functionality implemented as portions of the computing device of FIG. 1 for adjusting the lighting intensity of a face chart to enhance a 3D effect according to various embodiments of the present disclosure.

FIG. 4 illustrates an example user interface provided on a display of the computing device according to various embodiments of the present disclosure.

FIG. 5 illustrates the computing device of FIG. 1 generating a two-dimensional (2D) face chart from an image of the user's face according to various embodiments of the present disclosure.

FIG. 6 illustrates the computing device of FIG. 1 generating a 3D face chart and adjusting lighting effects on the 3D face chart according to various embodiments of the present disclosure.

### DETAILED DESCRIPTION

The subject disclosure is now described with reference to the drawings, where like reference numerals are used to refer to like elements throughout the following description. Other aspects, advantages, and novel features of the disclosed subject matter will become apparent from the following detailed description and corresponding drawings.

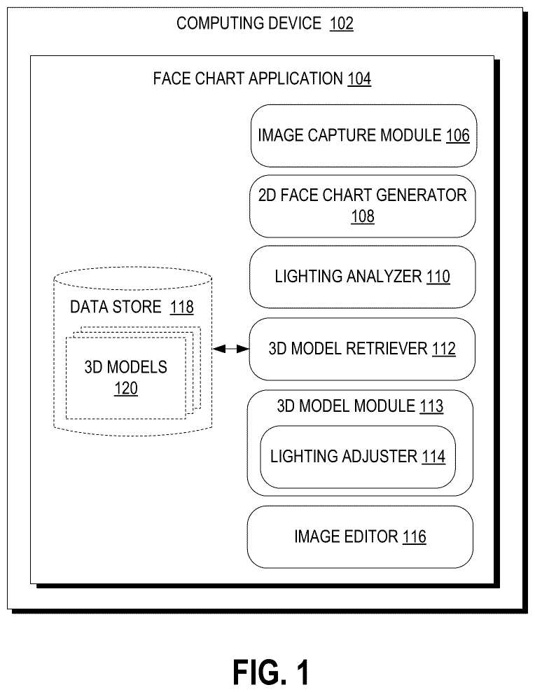

Embodiments are disclosed for generating more realistic three-dimensional (3D) face charts depicting a user's facial features, thereby facilitating the selection and application of cosmetic products. A description of a system for adjusting the lighting intensity of a 2Dface chart to enhance a stereoscopic effect of the 2D face chart is described followed by a discussion of the operation of the components within the system. FIG. 1 is a block diagram of a computing device 102 in which the embodiments disclosed herein may be implemented. The computing device 102 may comprise one or more processors that execute machine executable instructions to perform the features described herein. For example, the computing device 102 may be embodied as a computing device such as, but not limited to, a smartphone, a tablet-computing device, a laptop, and so on.

A face chart application 104 executes on a processor of the computing device 102 and includes an image capture module 106, a two-dimensional (2D) face chart generator 108, a lighting analyzer 110, a 3D model retriever 112, a 3D model module 113, and an image editor 116. The image capture module 106 is configured to obtain digital images of a user's facial region and displays the user's face on a display of the computing device 102. The computing device 102 may also be equipped with the capability to connect to the Internet, and the image capture module 106 may be configured to obtain an image or video of the user from another device or server.

The images obtained by the image capture module 106 may be encoded in any of a number of formats including, but not limited to, JPEG (Joint Photographic Experts Group) files, TIFF (Tagged Image File Format) files, PNG (Portable Network Graphics) files, GIF (Graphics Interchange Format) files, BMP (bitmap) files or any number of other digital formats. The video may be encoded in formats including, but not limited to, Motion Picture Experts Group (MPEG)-1, MPEG-2, MPEG-4, H.264, Third Generation Partnership Project (3GPP), 3GPP-2, Standard-Definition Video (SD-Video), High-Definition Video (HD-Video), Digital Versatile Disc (DVD) multimedia, Video Compact Disc (VCD) multimedia, High-Definition Digital Versatile Disc (HD-DVD) multimedia, Digital Television Video/High-definition Digital Television (DTV/HDTV) multimedia, Audio Video Interleave (AVI), Digital Video (DV), QuickTime (QT) file, Windows Media Video (WMV), Advanced System Format (ASF), Real Media (RM), Flash Media (FLV), an MPEG Audio Layer III (MP3), an MPEG Audio Layer II (MP2), Waveform Audio Format (WAV), Windows Media Audio (WMA), 360 degree video, 3D scan model, or any number of other digital formats.

The 2D face chart generator 108 is executed by the processor of the computing device 102 to identify facial features in the image obtained by the image capture module 106 and extract characteristics of the facial features in the image. The characteristics may comprise the size and shape of each facial feature depicted in the image, the overall size and shape of the user's face, contouring information of the user's face, and so on. The 2D face chart generator 108 generates a 2D face chart based on these facial feature characteristics, where the 2D face chart depicts the user's facial features. The 2D face chart generator 108 is further configured to predict the skin tone of the user's face depicted in the image.

A 3D model retriever 112 accesses a data store 118 containing predefined 3D models 120 and retrieves a 3D model 120 that most closely matches the user's face based on the facial characteristics. The 2D face chart generator 108 is configured to change or adjust color in a color map of a predefined 3D model based on the predicted skin tone, where the color map may comprise, for example, an albedo map.

The lighting analyzer 110 is executed to analyze the lighting environment depicted in the image of the user's face and to obtain lighting characteristics of the user's face. Such lighting characteristics may include the lighting intensity of each pixel in the facial region of the user and reflects such attributes as the positioning of one or more light sources relative to the user in the image. For some embodiments, the lighting analyzer 110 is configured to select a predefined environment map based on characteristics of the image. Such characteristics may comprise, for example, an average value of luminance, chrominance, chroma, color temperature, and/or contrast levels in the image. The environment map may comprise, for example, information relating to environmental lighting, predefined environmental lighting associated with different events, a high dynamic range image (HDRI) map, and so on. The events may include, for example, indoor events and outdoor events.

The 3D model module 113 is executed to generate a target face image based on the predefined 3D model. For some embodiments, the 3D module 113 superimposes the target face image onto the 2D face chart based on locations of facial features in the target face image. For some embodiments, the 3D module 113 outputs a final 2D face chart with adjusted lighting. The 3D model module 113 includes a lighting adjuster 114 configured to generate one or more lighting effects on the 2D face chart based on the lighting characteristics of the user's face depicted in the image, thereby enhancing a stereoscopic effect of the 2D face chart. In particular, the lighting adjuster 114 is configured to update the predefined 3D model using the environment map to generate a target face image with stereoscopic, lighting, and shadow effects. For some embodiments, the 3D model module 113 generates a final 2D face chart by superimposing the target face image onto the 2D face chart based on locations of facial features in the target face image. The image editor 116 is executed to perform virtual application of one or more cosmetic products on the user's face utilizing the final2D face chart depicting the one or more lighting effects applied by the lighting adjuster 114 in the 3D model module 113.

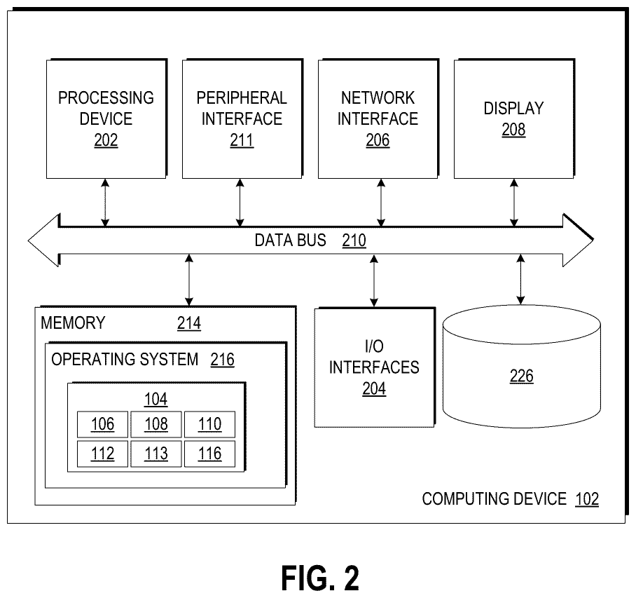

FIG. 2 illustrates a schematic block diagram of the computing device 102 in FIG. 1. The computing device 102 may be embodied as a desktop computer, portable computer, dedicated server computer, multiprocessor computing device, smart phone, tablet, and so forth. As shown in FIG. 2, the computing device 102 comprises memory 214, a processing device 202, a number of input/output interfaces 204, a network interface 206, a display 208, a peripheral interface 211, and mass storage 226, wherein each of these components are connected across a local data bus 210.

The processing device 202 may include a custom made processor, a central processing unit (CPU), or an auxiliary processor among several processors associated with the computing device 102, a semiconductor based microprocessor (in the form of a microchip), a macroprocessor, one or more application specific integrated circuits (ASICs), a plurality of suitably configured digital logic gates, and so forth.

The memory 214 may include one or a combination of volatile memory elements (e.g., random-access memory (RAM) such as DRAM and SRAM) and nonvolatile memory elements (e.g., ROM, hard drive, tape, CDROM). The memory 214 typically comprises a native operating system 216, one or more native applications, emulation systems, or emulated applications for any of a variety of operating systems and/or emulated hardware platforms, emulated operating systems, etc. For example, the applications may include application specific software that may comprise some or all the components of the computing device 102 displayed in FIG. 1.

In accordance with such embodiments, the components are stored in memory 214 and executed by the processing device 202, thereby causing the processing device 202 to perform the operations/functions disclosed herein. For some embodiments, the components in the computing device 102 may be implemented by hardware and/or software.

Input/output interfaces 204 provide interfaces for the input and output of data. For example, where the computing device 102 comprises a personal computer, these components may interface with one or more input/output interfaces 204, which may comprise a keyboard or a mouse, as shown in FIG. 2. The display 208 may comprise a computer monitor, a plasma screen for a PC, a liquid crystal display (LCD) on a hand held device, a touchscreen, or other display device.

In the context of this disclosure, a non-transitory computer-readable medium stores programs for use by or in connection with an instruction execution system, apparatus, or device. More specific examples of a computer-readable medium may include by way of example and without limitation: a portable computer diskette, a random access memory (RAM), a read-only memory (ROM), an erasable programmable read-only memory (EPROM, EEPROM, or Flash memory), and a portable compact disc read-only memory (CDROM) (optical).

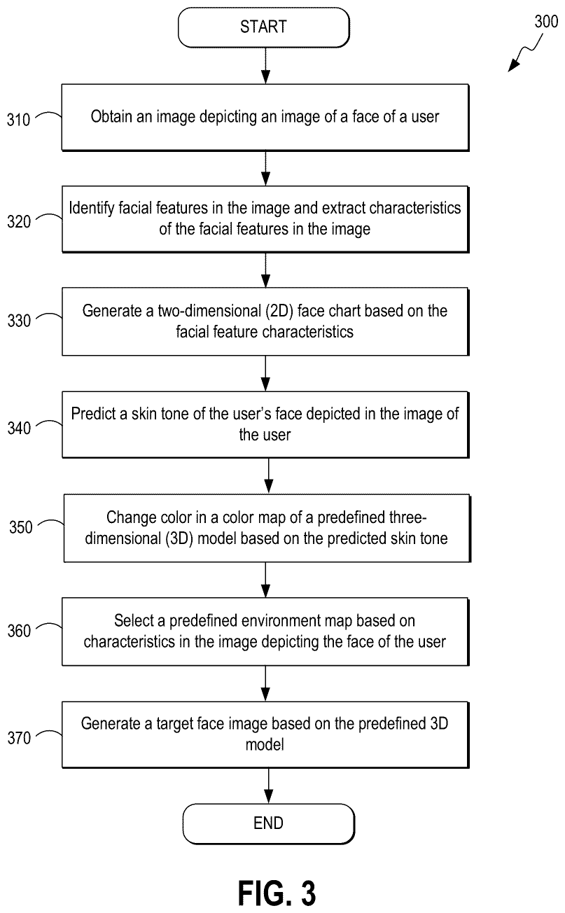

Reference is made to FIG. 3, which is a flowchart 300 in accordance with various embodiments for adjusting the lighting intensity of a face chart to enhance a 3D effect, where the operations are performed by the computing device 102 of FIG. 1. It is understood that the flowchart 300 of FIG. 3 provides merely an example of the different types of functional arrangements that may be employed to implement the operation of the various components of the computing device 102. As an alternative, the flowchart 300 of FIG. 3 may be viewed as depicting an example of steps of a method implemented in the computing device 102 according to one or more embodiments.

Although the flowchart 300 of FIG. 3 shows a specific order of execution, it is understood that the order of execution may differ from that which is displayed. For example, the order of execution of two or more blocks may be scrambled relative to the order shown. In addition, two or more blocks shown in succession in FIG. 3 may be executed concurrently or with partial concurrence. It is understood that all such variations are within the scope of the present disclosure.

At block 310, the computing device 102 obtains an image depicting a face of a user. At block 320, the computing device 102 identifies facial features in the image and extracts characteristics of the facial features in the image. At block 330, the computing device 102 generates a two-dimensional (2D) face chart based on the facial feature characteristics.

At block 340, the computing device 102 predicts a skin tone of the user's face depicted in the image of the user. For some embodiments, the computing device 102 predicts the skin tone of the user's face depicted in the image of the user by applying a machine-learning algorithm. At block 350, the computing device 102 changes color in a color map of a predefined 3D model based on the predicted skin tone.

At block 360, the computing device 102 selects a predefined environment map based on characteristics in the image depicting the face of the user. For some embodiments, the characteristics comprise an average value of luminance, chrominance, chroma, color temperature, and/or contrast levels in the image. The environment map may comprise, for example, information relating to environmental lighting, predefined environmental lighting associated with different events, a high dynamic range image (HDRI) map, and so on. The events may include, for example, indoor events and outdoor events.

At block 370, the computing device 102 generates a target face image based on the predefined 3D model. For some embodiments, the computing device 102 generates the target face image based on the predefined 3D model using physically based rendering and image-based lighting (IBL).

For some embodiments, the computing device 102 superimposes the target face image onto the 2D face chart based on locations of facial features in the target face image. For some embodiments, the computing device 102 generates a final 2D face chart based on the target face image by superimposing the target face image onto the 2D face chart based on locations of facial features in the target face image. Thereafter, the process in FIG. 3 ends.

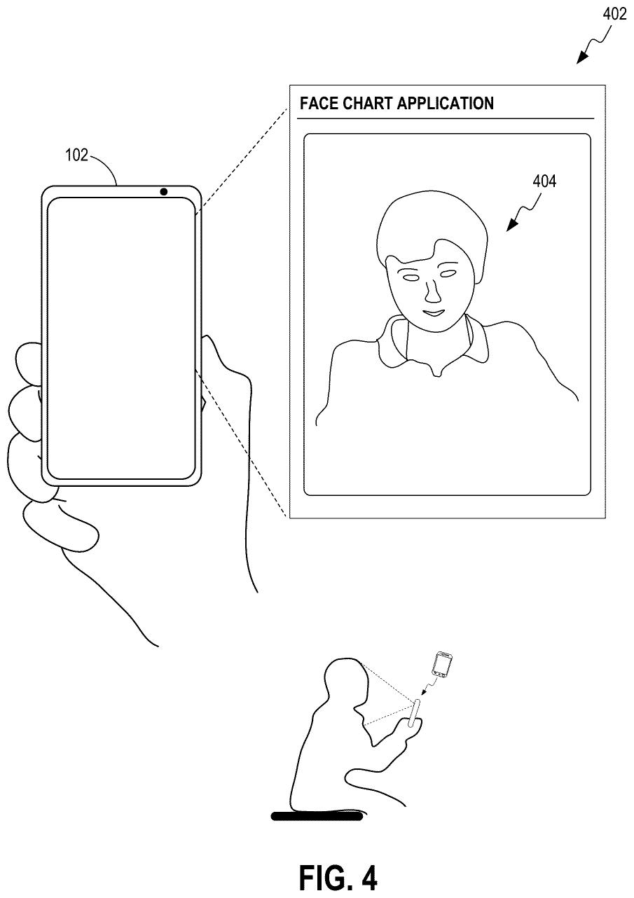

To illustrate various features of the present invention, reference is made to the figures described below. FIG. 4 illustrates an example user interface 402 provided on a display of the computing device 102 whereby an image of the user's face 404 is captured and displayed to the user. For some implementations, the image capture module 106 (FIG. 1) executing in the computing device 102 may be configured to cause a front-facing camera of the computing device 102 to capture an image or a video of a user's face 404 for purposes of generating a face chart of the user's face. The computing device 102 may also be equipped with the capability to connect to the Internet, and the image capture module 106 may be configured to obtain an image or video of the user from another device or server.

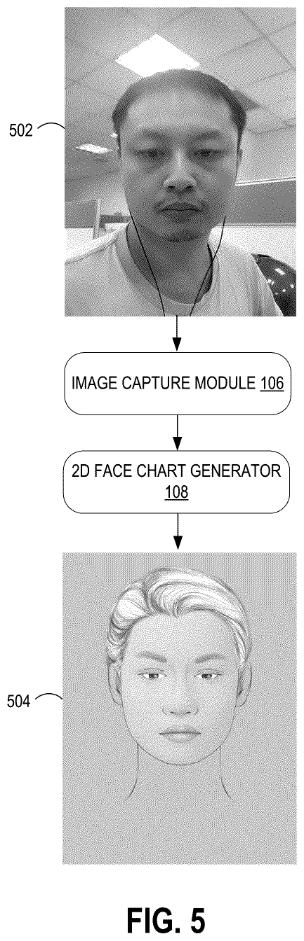

FIG. 5 illustrates the computing device 102 of FIG. 1 generating a 2D face chart from an image of the user's face according to various embodiments. As described above, the image capture module 106 obtains a digital image 502 of a user's facial region and displays the user's face. The 2D face chart generator 108 identifies facial features depicted in the image 502 obtained by the image capture module 106 and extracts characteristics of the facial features in the image. Such characteristics may comprise the size and shape of each facial feature depicted in the image, the overall size and shape of the user's face, contouring of the user's face, and so on. The 2D face chart generator 108 generates a 2D face chart 504 based on these facial feature characteristics, where the 2D face chart 504 depicts the user's facial features. The 2D face chart generator 108 is further configured to predict the skin tone of the user's face depicted in the image and adjust the color of the 2D face chart 504 according to the predicted skin tone. For some embodiments, the 2D face chart generator 108 predicts the skin tone of the user's face depicted in the image of the user is performed by applying a machine-learning algorithm.

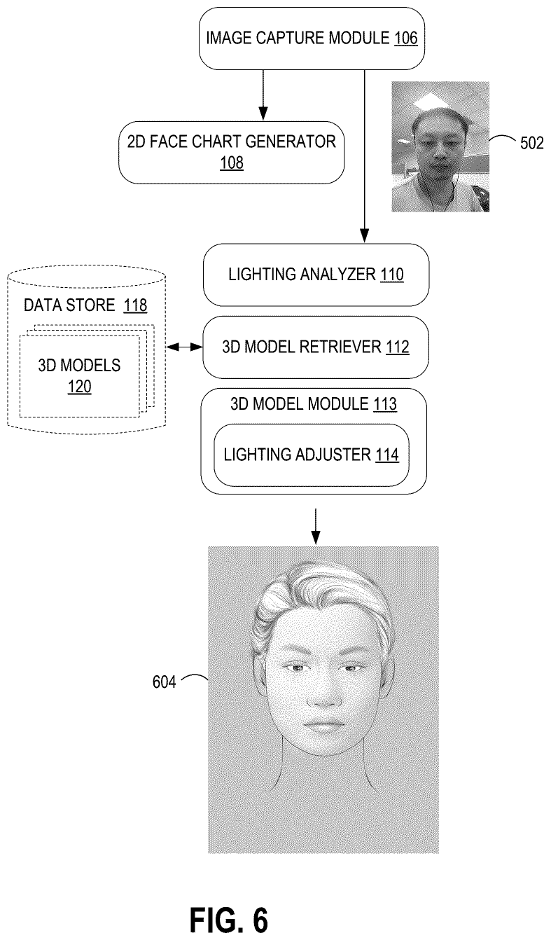

FIG. 6 illustrates the computing device 102 of FIG. 1 generating a final 2D face chart 604 and adjusting lighting effects on the final 2D face chart 604 according to various embodiments. The lighting analyzer 110 receives the image 502 of the user's face obtained by the image capture module 106 and analyzes the lighting environment depicted in the image 502 to obtain lighting characteristics of the user's face. Such lighting characteristics may include the lighting intensity of each pixel in the facial region of the user, which may be attributed to, for example, positioning of one or more light sources with respect to the user's face. For some embodiments, the lighting analyzer 110 is configured to select a predefined environment map based on, for example, an average value of luminance, chrominance, chroma, color temperature, and/or contrast levels in the image. The environment map may comprise, for example, information relating to environmental lighting, predefined environmental lighting associated with different events, a high dynamic range image (HDRI) map, and so on. The events may include, for example, indoor events and outdoor events.

The 3D model retriever 112 in the 3D model module 113 analyzes the facial characteristics obtained by the 2D face chart generator 108 (FIG. 5). Such facial characteristics may include the size and shape of each facial feature depicted in the image, the overall size and shape of the user's face, contouring of the user's face, and so on. For some embodiments, the 3D model retriever 112 obtains lighting characteristics of the user's face depicted in the image by obtaining a luminance, chrominance, chroma, color temperature, or contrast level for each pixel in the user's face depicted in the image 502 and determining an average value of the luminance, chrominance, chroma, color temperature, or contrast levels of the pixels in the user's face.

The 3D model retriever 112 accesses a data store 118 containing predefined 3D models 120 and retrieves a 3D model 120 that most closely matches the user's face based on the facial characteristics. The lighting adjuster 114 generates one or more lighting effects on the final 2D face chart 604 based on the lighting characteristics of the user's face depicted in the image, thereby enhancing a stereoscopic effect of the final 2D face chart 604. For some embodiments, the lighting adjuster 114 generates the one or more lighting effects on the final 2D face chart 604 by obtaining a luminance, chrominance, chroma, color temperature, or contrast level for each pixel in the image, determining an average value of the luminance, chrominance, chroma, color temperature, or contrast levels of the pixels in the image for selecting a predefined environment map.

The lighting adjuster 114 generates the one or more lighting effects by determining a new brightness level for each pixel in the 3D face chart 604 effects based on a weighting value, the average value of the brightness levels of the pixels in the user's face, and the average value of the brightness levels of the pixels in the 2D face chart.

For some embodiments, the lighting adjuster 114 determines the new brightness level for each pixel in the 3D face chart 604 based on a ratio of the average value of all the brightness levels of the pixels in the user's face to the average value of all the brightness levels of the pixels in the 2D face chart. In particular, let the value (T) represent the brightness level for a particular pixel in the image 502 of the user. The lighting adjuster 114 obtains an average value of the brightness levels from the image 502 of the user's face (represented by X). The lighting adjuster 114 similarly obtains an average value of the brightness levels from the 3D face chart 604 (represented by Y). The light adjuster 114 calculates a new brightness level (T′) for a corresponding pixel in the 3D chart based on the following expression:

$${T}^{′} = T ( \frac{X}{Y} )$$

A lighting effect based on the new brightness level (T′) is applied by the light adjuster 114 to each pixel in the 3D face chart 604. The light effect applied to the 3D face chart 604 simulates the lighting environment (e.g., the shading) depicted in the image 502 of the user's face, thereby enhancing a stereoscopic effect of the 3D face chart 604.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are included herein within the scope of this disclosure and protected by the following claims.

At least the following is claimed:

1. A method implemented in a computing device, comprising:
obtaining an image depicting a face of a user;
identifying facial features in the image and extracting characteristics of the facial features in the image;
generating a two-dimensional (2D) face chart based on the facial feature characteristics;
predicting a skin tone of the user's face depicted in the image of the user;
changing color in a color map of a predefined three-dimensional (3D) model based on the predicted skin tone;
selecting a predefined environment map based on characteristics in the image depicting the face of the user; and
generating a target face image based on the predefined 3D model.

2. The method of claim 1, wherein generating the target face image based on the predefined 3D model is performed using physically based rendering and image-based lighting (IBL).

3. The method of claim 1, further comprising superimposing the target face image onto the 2D face chart based on locations of facial features in the target face image.

4. The method of claim 1, wherein the color map comprises an albedo map.

5. The method of claim 1, wherein the characteristics in the image comprise at least one of: an average value of luminance, chrominance, chroma, color temperature, or contrast levels in the image.

6. The method of claim 1, wherein the environment map comprises information relating to environmental lighting.

7. The method of claim 6, wherein the environment map comprises predefined environmental lighting associated with different events.

8. The method of claim 1, wherein the environment map comprise a high dynamic range image (HDRI) map.

9. The method of claim 1, wherein predicting the skin tone of the user's face depicted in the image of the user is performed by applying a machine-learning algorithm. least:

10. A system, comprising:
a memory storing instructions;
a processor coupled to the memory and configured by the instructions to at
obtain an image depicting a face of a user;
identify facial features in the image and extract characteristics of the facial features in the image;
generate a two-dimensional (2D) face chart based on the facial feature characteristics;
predict a skin tone of the user's face depicted in the image of the user;
change color in a color map of a predefined three-dimensional (3D) model based on the predicted skin tone;
select a predefined environment map based on characteristics in the image depicting the face of the user; and
generate a target face image based on the predefined 3D model.

11. The system of claim 10, wherein the processor is configured to generate the target face image based on the predefined 3D model using physically based rendering and image-based lighting (IBL).

12. The system of claim 10, wherein the color map comprises an albedo map.

13. The system of claim 10, wherein the characteristics in the image comprise at least one of: an average value of luminance, chrominance, chroma, color temperature, or contrast levels in the image.

14. The system of claim 10, wherein the environment map comprises information relating to environmental lighting.

15. The system of claim 14, wherein the environment map comprises predefined environmental lighting associated with different events.

16. The system of claim 10, wherein the environment map comprise a high dynamic range image (HDRI) map.

17. The system of claim 10, wherein the processor is configured to predict the skin tone of the user's face depicted in the image of the user by applying a machine-learning algorithm.

18. A non-transitory computer-readable storage medium storing instructions to be implemented by a computing device having a processor, wherein the instructions, when executed by the processor, cause the computing device to at least:
obtain an image depicting a face of a user;
identify facial features in the image and extract characteristics of the facial features in the image;
generate a two-dimensional (2D) face chart based on the facial feature characteristics;
predict a skin tone of the user's face depicted in the image of the user;
change color in a color map of a predefined three-dimensional (3D) model based on the predicted skin tone;
select a predefined environment map based on characteristics in the image depicting the face of the user; and
generate a target face image based on the predefined 3D model.

19. The non-transitory computer-readable storage medium of claim 18, wherein the processor is configured by the instructions to generate the target face image based on the predefined 3D model using physically based rendering and image-based lighting (IBL).

20. The non-transitory computer-readable storage medium of claim 18, wherein the color map comprises an albedo map.
